(19) United States
(12) Patent Application Publication
(10) Pub. No.: US 2025/0393095 A1
(43) Pub. Date: Dec. 25, 2025

(54) BASE STATION, WIRELESS TERMINAL, COMMUNICATION METHOD, AND PROGRAM

(71) Applicant: NEC Corporation, Minato-ku, Tokyo (JP)

(72) Inventor: Satoaki HAYASHI, Tokyo (JP)

(73) Assignee: NEC Corporation, Minato-ku, Tokyo (JP)

(21) Appl. No.: 18/879,354

(22) PCT Filed: Jul. 21, 2023
(86) PCT No.: PCT/JP2023/026896

§ 371 Date: Dec. 27, 2024

(30) Foreign Application Priority Data
Jul. 29, 2022 (JP) 2022-122191

(51) Int. Cl. H04W 76/27; H04W 88/12

(52) U.S. Cl. CPC H04W 76/27; H04W 88/12

(57) ABSTRACT

An object is to provide a base station capable of reducing a time required for a wireless terminal to transmit information related to a flight status. A base station according to the present disclosure includes: a transmission unit configured to transmit, to at least one wireless terminal, instruction information instructing to transmit flight-related information regarding the wireless terminal in an RRC INACTIVE state; and a reception unit configured to receive, from the wireless terminal that has received the instruction information, the flight-related information in the RRC INACTIVE state.

### TECHNICAL FIELD

The present disclosure relates to a base station, a wireless terminal, a communication method, and a program.

### BACKGROUND ART

In recent years, a communication method in an uncrewed aerial vehicle (UAV), which is an uncrewed flight terminal, and an uncrewed aerial system (UAS) including a UAV controller has been studied in the 3rd generation partnership project (3GPP) (registered trademark).

Communication between the UAV and the UAV controller may be referred to as C2 (Command and Control) communication. For example, Non Patent Literature 1 defines UAS Traffic Management (UTM)-navigated C2 communication. The UTM entity executes, for example, tracking regarding the UAV, authentication regarding the UAV and the UAV controller, and the like. In the UTM-navigated C2 communication, for example, the UTM entity provides a flight plan, updates a flight route, monitors a flight status of the UAV, and navigates the UAV for autonomous flight for the UAV.

Here, a procedure for the UAV to transmit information regarding a flight status is disclosed in Non Patent Literature 2. In Non Patent Literature 2, for example, in a case where user equipment (UE) (corresponding to the UAV) in an RRC_IDLE state receives RRCConnection Setup from a base station, the UE transitions to an RRC_CONNECTED state and transmits an RRCConnectionSetupComplete message including flightPath InfoAvailable to the base station. Accordingly, the base station recognizes that the UE holds the information corresponding to the flight status. Then, the base station transmits the UEInformationRequest message to the UE in the RRC_CONNECTED state. The UE transmits, to the base station, a UEInformationResponse message that is a response message to the received message. At this time, in a case where a flightPathInfoReq field is set in the UEInformationRequest message, the UE includes, in the UEInformationResponse message, a flightPathInfoReport (corresponding to the flight status) including a list of waypoints (relay points) along the flight path of the UE.

The RRC_IDLE state is a state in which the context of the UE is not held in the UE and the base station. The RRC_CONNECTED state is a state in which a connection between the UE and the base station is established. In addition, in 3GPP, an RRC_INACTIVE state is defined as a state between the RRC_CONNECTED state and the RRC_IDLE state. The RRC_INACTIVE state is a state in which the UE and the base station hold the context of the UE, but the connection between the UE and the base station is released. Therefore, in the RRC_INACTIVE state, the power saving state can be kept similarly to the RRC_IDLE state.

### CITATION LIST

### Non Patent Literature

Non Patent Literature 1: 3GPP TS 22.125 V17.6.0 (2022-03)
Non Patent Literature 2: 3GPP TS 36.331 V17.0.0 (2022-03)

### SUMMARY OF INVENTION

### Technical Problem

In the communication processing disclosed in Non Patent Literature 2, in a case where the UAV transmits the information regarding the flight status, it is necessary to be in the RRC_CONNECTED state. That is, after transitioning to the RRC_CONNECTED state, and further receiving, from the base station, the UEInformationRequest message in which the flightPathInfoReq field is set, the UE in the RRC_IDLE state or the RRC_INACTIVE state can further transmit the information regarding the flight status. However, the transition to the RRC_CONNECTED state requires a predetermined time, and after the transition to the RRC_CONNECTED state, a predetermined time is further required until the UEInformationRequest message in which the flightPathInfoReq field is set is received from the base station. Therefore, there is a problem that it takes time for the UAV to transmit information related to its own flight status to the UTM entity or the like.

In view of the above-described problems, an object of the present disclosure is to provide a base station, a wireless terminal, a communication method, and a program capable of reducing a time required for a wireless terminal to transmit information related to a flight status.

### Solution to Problem

A base station according to a first aspect of the present disclosure includes: a transmission unit configured to transmit, to at least one wireless terminal, instruction information instructing to transmit flight-related information regarding the wireless terminal in an RRC INACTIVE state; and a reception unit configured to receive, from the wireless terminal that has received the instruction information, the flight-related information in the RRC INACTIVE state.

A wireless terminal according to a second aspect of the present disclosure includes: a reception unit configured to receive, from a base station, instruction information instructing to transmit flight-related information in an RRC INACTIVE state; and a transmission unit configured to transmit the flight-related information to the base station in the RRC INACTIVE state on the basis of the instruction information.

A communication method executed in a base station according to a third aspect of the present disclosure includes: transmitting, to at least one wireless terminal, instruction information instructing to transmit flight-related information regarding the wireless terminal in an RRC INACTIVE state; and receiving, from the wireless terminal that has received the instruction information, the flight-related information in the RRC INACTIVE state.

A communication method executed in a wireless terminal according to a fourth aspect of the present disclosure includes: receiving, from a base station, instruction information instructing to transmit flight-related information in an RRC INACTIVE state: and transmitting the flight-related information to the base station in the RRC INACTIVE state on the basis of the instruction information.

A program according to a fifth aspect of the present disclosure causes a computer to execute: transmitting, to at least one wireless terminal, instruction information instructing to transmit flight-related information regarding the wireless terminal in an RRC INACTIVE state; and receiving, from the wireless terminal that has received the instruction information, the flight-related information in the RRC INACTIVE state.

A program according to a sixth aspect of the present disclosure causes a computer to execute: receiving, from a base station, instruction information instructing to transmit flight-related information in an RRC INACTIVE state; and transmitting the flight-related information to the base station in the RRC INACTIVE state on the basis of the instruction information.

### Advantageous Effects of Invention

According to the present disclosure, it is possible to provide a base station, a wireless terminal, a communication method, and a program capable of reducing a time required for a wireless terminal to transmit information related to a flight status.

### BRIEF DESCRIPTION OF DRAWINGS

FIG. 1 is a configuration diagram of a base station according to the present disclosure.

FIG. 2 is a configuration diagram of a wireless terminal according to the present disclosure.

FIG. 3 is a diagram illustrating a flow of communication processing executed in the base station according to the present disclosure.

FIG. 4 is a diagram illustrating a flow of communication processing executed in the wireless terminal according to the present disclosure.

FIG. 5 is a configuration diagram of a communication system according to the present disclosure.

FIG. 6 is a diagram illustrating a flow of transmission processing of broadcast information according to the present disclosure.

FIG. 7 is a diagram illustrating a flow of SDT processing according to the present disclosure.

FIG. 8 is a configuration diagram of a base station according to the present disclosure.

FIG. 9 is a configuration diagram of a wireless terminal according to the present disclosure.

### EXAMPLE EMBODIMENTS

### First Example Embodiment

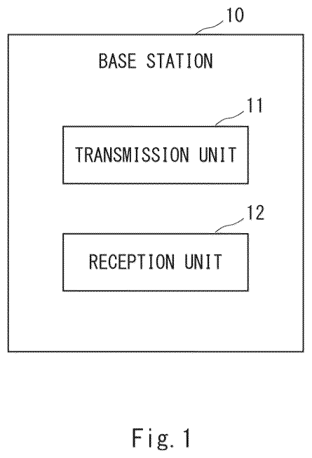

Hereinafter, a configuration example of a base station 10 will be described with reference to FIG. 1. The base station 10 may be a computer apparatus that operates in a case where a processor executes a program stored in a memory. The base station 10 may be, for example, a gNB (g Node B) defined in the 3rd Generation Partnership Project (3GPP).

The base station 10 includes a transmission unit 11 and a reception unit 12. The transmission unit 11 and the reception unit 12 may be software components or modules whose processing is carried out by causing the processor to execute the program stored in the memory. Alternatively, the transmission unit 11 and the reception unit 12 may be hardware components such as circuits or chips.

The transmission unit 11 transmits, to at least one wireless terminal, instruction information instructing to transmit flight-related information regarding the wireless terminal in an RRC INACTIVE state. The wireless terminal may be, for example, a terminal of which a flight operation is controlled using a controller. Alternatively, the wireless terminal may be a terminal that autonomously flies according to a predetermined flight route and flight plan. The wireless terminal may be, for example, a drone. Alternatively, the wireless terminal may be a controller that controls a flight operation of a flying terminal. In addition, the wireless terminal may correspond to UE used as a general term for terminals in 3GPP.

The RRC INACTIVE state is a state of the UE defined in 3GPP. In 3GPP, in addition to the RRC INACTIVE state, an RRC IDLE state and an RRC CONNECTED state are defined as the state of UE. The RRC INACTIVE state is a state in which a connection between the UE and the base station is not established, and is a state in which scheduling of the UE by the base station is not performed. The scheduling may mean, for example, allocating a wireless resource used by the UE to receive downlink data or transmit uplink data. The allocation of wireless resources includes deciding transmission and reception timings of data in the UE, an amount of wireless resources to be used, and a location on a frequency axis.

As the wireless resource, a wireless resource defined in 3GPP that defines New Radio (NR) may be used as a wireless communication standard. In 3GPP, it is defined that one frame is constituted by 10 subframes. One subframe has a length of 1 ms (milliseconds). Further, one slot has 14 symbols in the case of Normal CP, and has a variable length depending on sub-carrier spacing. For example, sub-carrier spacing is set to 15 kHz, 30 kHz, 60 kHz, 120 kHz, and 240 KHz. For example, in a case where sub-carrier spacing is 15 kHz, one subframe includes one slot. In a case where sub-carrier spacing is 30 kHz, one subframe includes two slots. In a case where sub-carrier spacing is 60 kHz, one subframe includes four slots. In a case where sub-carrier spacing is 120 kHz, one subframe includes eight slots. In a case where sub-carrier spacing is 240 kHz, one subframe includes sixteen slots.

A wireless resource having one slot or one symbol as a minimum unit is allocated to the wireless terminal, and data is transmitted and received. The wireless resource may be referred to as a resource block. The uplink data is data transmitted by the wireless terminal to the base station 10, and the downlink data is data transmitted by the base station 10 to the wireless terminal. The uplink data and the downlink data include control data and user data. The control data may be referred to as, for example, control (C)-plane data, and the user data may be referred to as user (U)-plane data.

The flight-related information may include, for example, position information indicating a start point and a goal point of the wireless terminal, and position information indicating a relay point between the start point and the goal point. In addition, the flight-related information may include time information indicating an arrival time at the goal point and a passing time of each relay point. In addition, the flight-related information may include information indicating a flight altitude and a speed of the wireless terminal. In addition, the flight-related information may include information indicating a remaining battery level of the wireless terminal, a size of the wireless terminal, a size or weight of an object carried in a case where the wireless terminal carries the object, and the like.

The reception unit 12 receives the flight-related information in the RRC INACTIVE state from the wireless terminal that has received the instruction information. In the RRC INACTIVE state, the wireless terminal transmits the flight-related information to the base station 10 without transitioning to the RRC CONNECTED state.

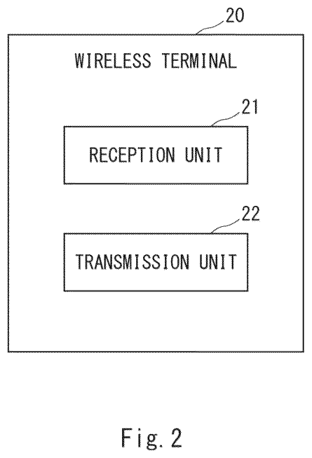

Next, a configuration example of the wireless terminal 20 according to a first example embodiment will be described with reference to FIG. 2. The wireless terminal 20 may be a computer apparatus that operates in a case where a processor executes a program stored in a memory. In addition, the flight of the wireless terminal 20 may be controlled by a controller or the like via a wireless communication line. Alternatively, the flight of the wireless terminal 20 may be controlled by a server apparatus or the like via a mobile network. Alternatively, the wireless terminal 20 may be a controller that controls a flight operation of a flying terminal.

The reception unit 21 receives, from the base station 10, instruction information instructing to transmit the flight-related information in the RRC INACTIVE state. The transmission unit 22 transmits the flight-related information to the base station in the RRC INACTIVE state, on the basis of the instruction information.

The wireless terminal 20 may hold the flight-related information in advance, or may acquire the flight-related information from another computer apparatus periodically or at any timing. The another computer apparatus may be, for example, a controller that operates the wireless terminal 20 via a wireless communication line, or may be a communication apparatus, a server apparatus, or the like that communicates via a mobile network. Alternatively, the wireless terminal 20 may acquire or detect the flight-related information by using a sensor or the like.

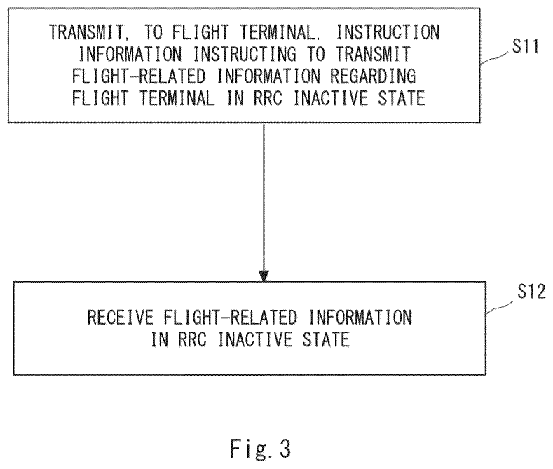

Next, a flow of communication processing executed in the base station 10 according to the first example embodiment will be described with reference to FIG. 3. First, the transmission unit 11 transmits, to at least one wireless terminal, instruction information instructing to transmit flight-related information regarding the wireless terminal in the RRC INACTIVE state (S11). Next, the reception unit 12 receives the flight-related information in the RRC INACTIVE state from the wireless terminal that has received the instruction information (S12).

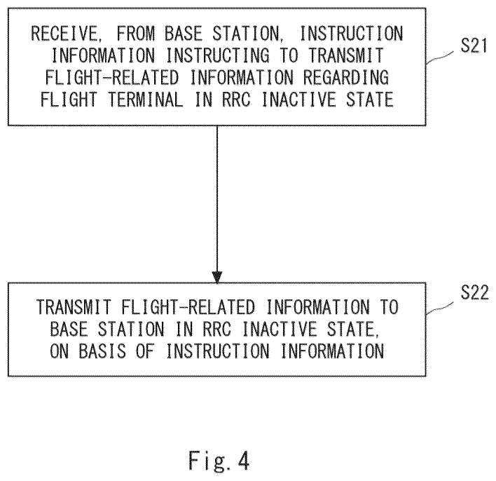

Next, a flow of communication processing executed in the wireless terminal 20 according to the first example embodiment will be described with reference to FIG. 4. First, the reception unit 21 receives, from the base station 10, instruction information instructing to transmit the flight-related information in the RRC INACTIVE state (S21). Next, the transmission unit 22 transmits the flight-related information to the base station 10 in the RRC INACTIVE state, on the basis of the instruction information (S22).

As described above, the wireless terminal 20 according to the first example embodiment transmits the flight-related information to the base station 10 in the RRC INACTIVE state on the basis of the instruction information received from the base station 10. Accordingly, the wireless terminal 20 can transmit the flight-related information to the base station 10 without transitioning to the RRC CONNECTED state. As a result, the wireless terminal 20 can reduce a time until the flight-related information is transmitted.

### Second Example Embodiment

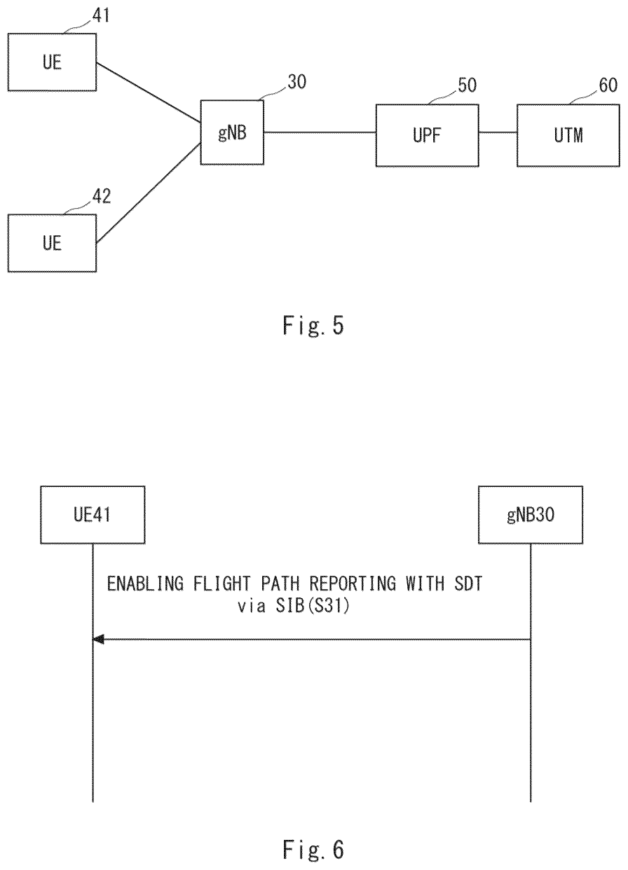

Next, a configuration example of a communication system according to a second example embodiment will be described with reference to FIG. 5. The communication system in FIG. 5 illustrates a communication system defined in 3GPP. For example, the communication system includes a gNB 30, a UE 41, a UE 42, a user plane function (UPF) entity 50 (hereinafter, referred to as a UPF 50), and a UTM entity 60 (hereinafter, referred to as a UTM 60). The entity may be referred to as an apparatus or a node.

The gNB 30 corresponds to the base station 10 in FIG. 1. The gNB 30 is a base station that supports wireless communication using 5th Generation (5G) which is a wireless communication standard defined in 3GPP. The gNB 30 manages a cell which is a communication area in which wireless communication can be performed, and performs wireless communication with the UE 41 and the UE 42 existing in the cell by using 5G.

The UE 41 and the UE 42 correspond to, for example, wireless terminals. The wireless terminal may be an uncrewed aerial vehicle terminal or a flight terminal that operates in an uncrewed manner. The wireless terminal may be a terminal that autonomously flies. In addition, any one of the UE 41 and the UE 42 may be a wireless terminal, and the other may be a controller that controls an operation of the wireless terminal by wirelessly communicating with the wireless terminal. The UE 41 and the UE 42 may be a UAV and a UAV controller. The UAV may be specifically a drone.

The UPF 50 corresponds to a core network apparatus constituting a 5G core (5GC). The UPF 50 relays U-Plane data regarding the UE 41 and the UE 42. For example, the UPF 50 may transmit the U-Plane data received from the UE 41 via the gNB 30 to another UE, or may transmit the U-Plane data transmitted from another UE to the UE 41 via the gNB 30.

The UTM 60 has several functions for managing autonomous flight of the UE 41 in a certain flight area. In other words, the UTM 60 provides services for managing the flight of the UE 41 in a certain flight area. For example, the UTM 60 has functions for identifying, tracking, approving, and the like of the UAV. The UTM 60 may acquire flight-related information from the UE 41 or the UE 42 and manage the flight of the UE 41.

Next, a flow of transmitting processing of broadcast information for the UE 41 according to the second example embodiment will be described with reference to FIG. 6. Although the flow of the processing of transmitting the broadcast information for the UE 41 is described in FIG. 6, the broadcast information may be similarly transmitted to the UE 42 and other UEs. First, the gNB 30 transmits or broadcasts a SIB indicating ENABLING FLIGHT PATH REPORTING WITH SDT to all the UEs including the UE 41 and existing in the cell managed by the gNB 30 (S31). The gNB 30 transmits a Master Information Block (MIB) to all UEs existing in the cell managed by the gNB 30 by a Physical Broadcast Channel (PBCH). In the MIB, a parameter for monitoring the PDCCH is configured. Monitoring the PDCCH may also be referred to as detecting or specifying the PDCCH. The scheduling information regarding the PDSCH in which the SIB is configured is configured in the PDCCH. The PDSCH in which the SIB is configured may also be referred to as a PDSCH including the SIB. That is, by receiving the MIB via the PBCH, the UE 41 can specify the wireless resource in which the SIB is configured, and receives the SIB.

ENABLING FLIGHT PATH REPORTING WITH SDT is information instructing the UE to transmit flight path information by using small data transmission (SDT). The flight path information may be referred to as a flight path report. In addition, ENABLING FLIGHT PATH REPORTING WITH SDT is configured in the SIB or included in the SIB and transmitted. ENABLING FLIGHT PATH REPORTING WITH SDT may be configured in a SIB of which use is already defined in 3GPP, or may be configured in a newly defined SIB. The SDT is a procedure that allows the UE to transmit data in the RRC INACTIVE state or transmit data in the RRC INACTIVE state. The UE may transmit uplink data by using the SDT in a case where the data amount or data size of the uplink data to be transmitted to the gNB 30 is less than or smaller than a predetermined value. In other words, the UE may start the SDT in a case where the data amount or data size of the uplink data stored in a buffer that transmits the uplink data is less than or smaller than the predetermined value. The case where the data amount or data size of the uplink data is less than or smaller than the predetermined value may be referred to as small data.

Flight path reporting may mean that the UE 41 transmits the flight path information to the gNB 30 in a case where the UE 41 is able to transmit the flight path information to the gNB 30. Being able to transmit the flight path information to the gNB 30 may be a state in which the UE 41 has a function of transmitting the flight path information to the gNB 30, or may be a state in which the UE 41 holds the flight path information.

The flight path information may include, for example, a maximum value of the number of relay points through which the UE 41 passes before reaching a destination and information regarding a timing at which the UE passes through the relay point. In addition, the flight path information may include information indicating the position of the relay point. The timing of passing through the relay point may be indicated by using, for example, a time stamp.

In the SIB in which ENABLING FLIGHT PATH REPORTING WITH SDT is configured, information regarding a timing at which the UE 41 reports the flight path information may be configured. The timing of reporting the flight path information may be periodic or may be any timing set by the gNB 30.

In addition, in the SIB in which ENABLING FLIGHT PATH REPORTING WITH SDT is configured, a threshold value of the data amount or data size of the flight path information stored in the buffer by the UE 41 may be set. For example, in a case where the data amount or data size of the flight path information stored in the buffer reaches a threshold value, the UE 41 may start the processing regarding the SDT in order to transmit the flight path information to the gNB 30. The threshold value of the data amount or data size of the flight path information may be set to a value different from a threshold value used for transmission of data different from the flight path information.

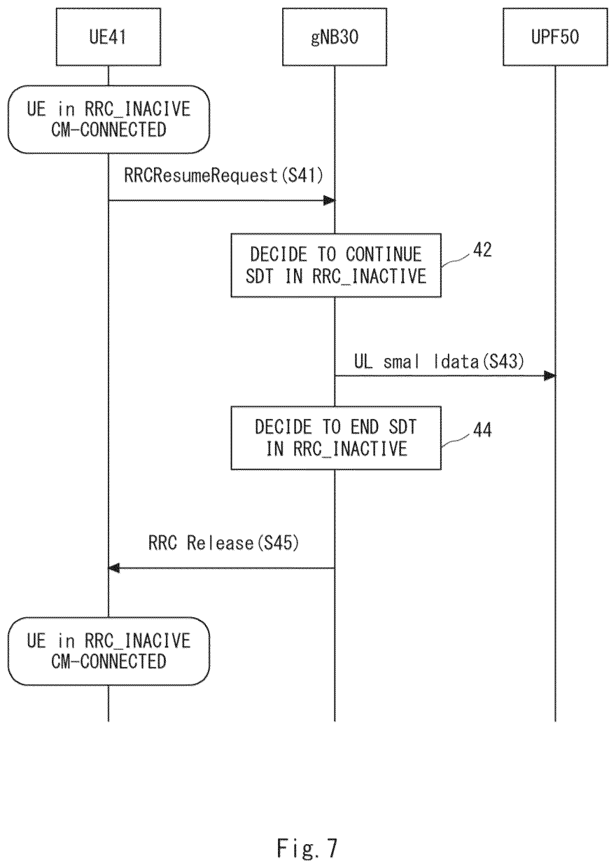

Next, a flow of SDT processing according to the second example embodiment will be described with reference to FIG. 7. FIG. 7 illustrates a procedure of a random access (RA) based SDT using a random access procedure.

In FIG. 7, it is assumed that the UE 41 has received ENABLING FLIGHT PATH REPORTING WITH SDT configured in the SIB. In addition, it is assumed that the UE 41 is in the RRC INACTIVE state and a CM-CONNECTED state. The CM-CONNECTED state is a state in which an NAS signaling connection is established between the UE 41 and an access and mobility management function (AMF) entity (not illustrated) which is a core network apparatus. In addition, the gNB 30 in FIG. 7 may be a gNB different from a gNB (last serving gNB) with which the UE 41 has performed communication last time. The gNB with which the UE 41 performs communication this time may be referred to as a receiving gNB.

First, the UE 41 transmits RRCResumeRequest to the gNB 30 together with at least one of the SDT data and the SDT signalling by the random access procedure (S41). Here, the UE 41 may transmit RRCResumeRequest to the gNB 30 by executing, for example, a 4-step random access (RA) type or 2-step RA type random access procedure. Specifically, the UE 41 transmits a preamble as a message 1 (MSG 1) to the gNB 30 by a physical random access channel (PRACH). In a case of receiving the response (random access response) to the MSG 1, the UE 41 transmits a MSG 3 (Message 3) to the gNB 30 according to an uplink (UL) grant scheduled in the random access response. The UL grant may indicate, for example, a timing and a wireless resource at which the gNB 30 transmits the uplink data.

The UE 41 may transmit RRCResumeRequest with the SDT data as the MSG 3 to the gNB 30. Here, the SDT data transmitted by the UE 41 in the MSG 3 may be flight path information. In addition, the flight path information may be transmitted in a signaling radio bearer (SRB) established or configured between the UE 41 and the gNB 30. The SRB is an RB for transmitting an RRC message and a non-access stratum (NAS). In 3GPP, SRB0 to SRB4 are defined as SRB. For example, the flight path information may be transmitted in the SRB2. The SRB 2 is an SRB used for transmission of an RRC message including logged measurement information.

Next, the gNB 30 decides to keep the RRC INACTIVE state for the SDT (S42). The gNB 30 may acquire the UE context regarding the UE 41 from the last serving gNB before step S42.

Next, the gNB 30 transmits UL small data to the UPF 50 (S43). The UL small data corresponds to the SDT data transmitted from the UE 41 to the gNB 30, and specifically corresponds to the flight path information. The UL small data may be, for example, uplink data having a data amount or data size less than or smaller than a predetermined data amount or data size. The flight path information is transmitted to the UTM 60 via the UPF 50.

Next, the gNB 30 decides to end the SDT by transmitting the UL small data (S44). Next, the gNB 30 transmits an RRC Release message to the UE 41 (S45). The RRC Release message includes a suspend indication indicating that the UE 41 is caused to transition to the RRC INACTIVE state. For example, in a case where uplink data not corresponding to the UL small data or uplink data not targeted for the SDT is to be transmitted, the UE 41 may transmit the data after transitioning to the RRC CONNECTED state. The UE 41 having transitioned to the RRC CONNECTED state as described above transitions to the RRC INACTIVE state in a case of receiving the RRC release message including the suspend indication. In the case of receiving the RRC release message including the suspend indication (or suspend configuration) in the RRC INACTIVE state, the UE 41 keeps the RRC INACTIVE state.

As described above, the gNB 30 according to the second example embodiment broadcasts the SIB in which ENABLING FLIGHT PATH REPORTING WITH SDT is configured, and the UE 41 can transmit the flight path information by using the SDT. By transmitting the flight path information by using the SDT, the UE 41 does not need to transition from the RRC INACTIVE state to the RRC CONNECTED state in order to transmit the flight path information. As a result, the UE 41 can reduce a time from occurrence of the necessity of transmitting the flight path information to the actual transmission of the flight path information.

### Third Example Embodiment

Next, notification processing of ENABLING FLIGHT PATH REPORTING WITH SDT according to a third example embodiment will be described. In the second example embodiment, an example has been described in which ENABLING FLIGHT PATH REPORTING WITH SDT is configured in the SIB, and ENABLING FLIGHT PATH REPORTING WITH SDT is broadcasted to all the UEs existing in the cell managed by the gNB 30.

Here, in the third example embodiment, an example will be described in which each UE is notified of ENABLING FLIGHT PATH REPORTING WITH SDT.

For example, the gNB 30 may notify the UE 41 of ENABLING FLIGHT PATH REPORTING WITH SDT by configuring ENABLING FLIGHT PATH REPORTING WITH SDT in the RRC Release message illustrated in FIG. 7. Specifically, the gNB 30 may configure ENABLING FLIGHT PATH REPORTING WITH SDT in the RRC Release message including the suspend indication.

By configuring ENABLING FLIGHT PATH REPORTING WITH SDT in the RRC release message including the suspend indication, which is transmitted to a specific UE, the specific UE may be instructed to use the SDT for transmitting the flight path information.

In addition to the SDT procedure in FIG. 7, for example, ENABLING FLIGHT PATH REPORTING WITH SDT may be configured in the RRC Release message including the suspend indication to be transmitted in a radio access network based notification area (RNA) update. The gNB 30 manages the RNA as the position information of the UE in the RRC INACTIVE state. The RNA is an area covering one or more cells, and may be an area included in a registration area managed by a core network. For example, the UE 41 may execute RNA update in a case of moving to an area different from the RNA currently configured or periodically. At this time, the UE 41 transmits the RRCResumeRequest to the gNB 30 and receives the RRC Release message including the suspend indication, similarly to the procedure illustrated in FIG. 7.

In addition, the UE 41 in the RRC INACTIVE state transmits RRCResumeRequest to the gNB 30 in a case where transitioning to the RRC CONNECTED state. At this time, the UE 41 transitions to the RRC CONNECTED state by receiving, from the gNB 30, RRCResume as a response to the RRCResumeRequest. After transitioning to the RRC CONNECTED state, the UE 41 transitions to the RRC INACTIVE state by receiving, from the gNB 30, the RRC release message including the suspend indication. ENABLING FLIGHT PATH REPORTING WITH SDT may be configured in the RRC release message including the suspend indication that is transmitted to transition the UE in the RRC CONNECTED state to the RRC INACTIVE state.

In a case of receiving the RRC Release message including the suspend indication in which ENABLING FLIGHT PATH REPORTING WITH SDT is configured, the UE 41 transmits the flight path information to the gNB 30 by using the SDT, similarly to the procedure described in FIG. 7. That is, the UE 41 may transmit the flight path information to the gNB 30 by using the RA based SDT.

Alternatively, the gNB 30 may configure UL grant indicating a resource for transmitting the flight path information in the RRC Release message. The UE 41 that has received the RRC release message including the UL grant transmits the flight path information to the gNB 30 by using the SDT. A procedure in which the UE 41 performs communication using the SDT on the basis of the UL grant may be referred to as a configured grant (CG) based SDT.

For example, in the RRC Release message including the suspend indication in which ENABLING FLIGHT PATH REPORTING WITH SDT is configured, whether the UE 41 uses the RA based SDT or the CG based SDT may be indicated.

As described above, the gNB 30 according to the third example embodiment transmits, to each UE, the RRC Release message including the suspend indication in which ENABLING FLIGHT PATH REPORTING WITH SDT is configured. Accordingly, the information configured in the SIB can be reduced as compared with the second example embodiment.

Here, for example, the gNB 30 may broadcast the SIB in which ENABLING FLIGHT PATH REPORTING WITH SDT is configured, and transmit, to each UE, the information regarding the timing at which the UE 41 reports the flight path information by using the RRC release message. Further, the gNB 30 may transmit, to each UE, the threshold value of the data amount or data size of the flight path information stored in the buffer by the UE 41 by using the RRC Release message.

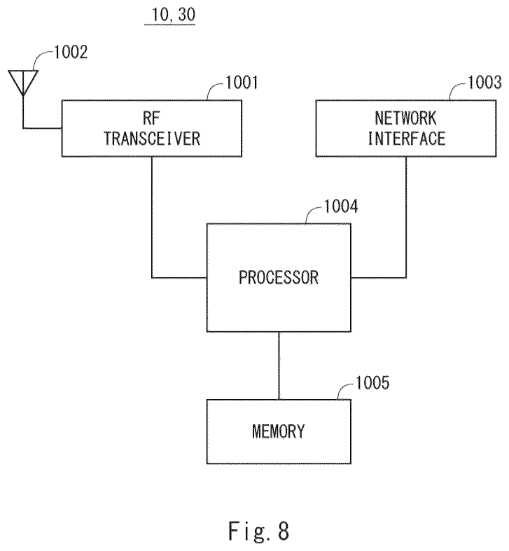

FIG. 8 is a block diagram illustrating a configuration example of the base station 10 and the gNB 30 (hereinafter, referred to as the base station 10 or the like). Referring to FIG. 8, the base station 10 or the like includes an RF transceiver 1001, a network interface 1003, a processor 1004, and a memory 1005. The RF transceiver 1001 performs analog RF signal processing to communicate with the UEs. The RF transceiver 1001 may include a plurality of transceivers. The RF transceiver 1001 is coupled with the antenna 1002 and the processor 1004. The RF transceiver 1001 receives modulated symbol data (or OFDM symbol data) from the processor 1004, generates a transmission RF signal, and supplies the transmission RF signal to the antenna 1002. Also, the RF transceiver 1001 generates a baseband reception signal on the basis of the reception RF signal received by the antenna 1002, and provides the baseband reception signal to the processor 1004.

The network interface 1003 is used to communicate with a network node (for example, other core network nodes). The network interface 1003 may include, for example, a network interface card (NIC) conforming to IEEE 802.3 series.

The processor 1004 performs data plane processing including digital baseband signal processing for wireless communication and control plane processing.

The processor 1004 may include a plurality of processors. For example, the processor 1004 may include a modem processor (for example, DSP) that performs digital baseband signal processing and a protocol stack processor (for example, CPU or MPU) that performs control plane processing.

The memory 1005 is configured by a combination of a volatile memory and a nonvolatile memory. The memory 1005 may include a plurality of physically independent memory devices. The volatile memory is, for example, a Static Random Access Memory (SRAM), a Dynamic RAM (DRAM), or a combination thereof. The nonvolatile memory is a masked Read Only Memory (MROM), an Electrically Erasable Programmable ROM (EEPROM), a flash memory, or a hard disk drive, or any combination thereof. The memory 1005 may include a storage disposed away from the processor 1004. In this case, the processor 1004 may access the memory 1005 through the network interface 1003 or an I/O interface (not illustrated).

The memory 1005 may store a software module (computer program) including a group of instructions and data for performing processing by the base station 10 or the like described in example embodiments as described above. In some implementations, the processor 1004 may be configured to perform the processing of the base station 10 or the like described in the example embodiments as described above by reading the software module from the memory 1005 and executing it.

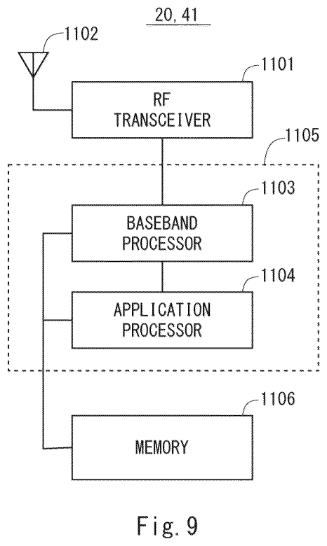

FIG. 9 is a block diagram illustrating a configuration example of the wireless terminal 20 and the UE 41 (hereinafter, referred to as the wireless terminal 20 or the like). A radio frequency (RF) transceiver 1101 performs analog RF signal processing to communicate with the access network node 20 or the gNB 30. The analog RF signal processing performed by the RF transceiver 1101 includes frequency up-conversion, frequency down-conversion, and amplification. The RF transceiver 1101 is coupled with an antenna 1102 and a baseband processor 1103. That is, the RF transceiver 1101 receives modulated symbol data (or OFDM symbol data) from the baseband processor 1103, generates a transmission RF signal, and supplies the transmission RF signal to the antenna 1102. In addition, the RF transceiver 1101 generates a baseband reception signal on the basis of the reception RF signal received by the antenna 1102 and provides the baseband reception signal to the baseband processor 1103.

The baseband processor 1103 performs digital baseband signal processing (data plane processing) for wireless communication and control plane processing. The digital baseband signal processing includes (a) data compression/restoration, (b) data segmentation/constellation, (c) generation/decomposition of a transmission format (transmission frame), (d) transmission path encoding/decoding, (e) modulation (symbol mapping)/demodulation, (f) generation of OFDM symbol data (baseband OFDM signal) by Inverse Fast Fourier Transform (IFFT), and the like. On the other hand, the control plane processing includes communication management of Layer 1, Layer 2, and Layer 3.

The baseband processor 1103 may include a modem processor (for example, digital signal processor (DSP)) that performs digital baseband signal processing and a protocol stack processor (for example, a central processing unit (CPU), or a micro processing unit (MPU)) that performs control plane processing. In this case, the protocol stack processor that performs the control plane processing may be shared with an application processor 1104 described later.

The application processor 1104 is also referred to as a CPU, an MPU, a microprocessor, or a processor core. The application processor 1104 may include a plurality of processors (a plurality of processor cores). The application processor 1104 implements various functions of the wireless terminal 20 and the like by executing a system software program (operating system (OS)) and various application programs (for example, a call application, a WEB browser, a mailer, a camera operation application, or a music playback application) read from the memory 1106 or a memory (not illustrated).

In some implementations, as indicated by a dashed line (1105) in FIG. 9, the baseband processor 1103 and the application processor 1104 may be integrated on one chip. In other words, the baseband processor 1103 and the application processor 1104 may be implemented as one system on chip (SoC) device 1105. The SoC device may also be referred to as a system large scale integration (LSI) or chipset.

The memory 1106 is a volatile memory, a nonvolatile memory, or a combination thereof. The memory 1106 may include a plurality of physically independent memory devices. The volatile memory is, for example, a Static Random Access Memory (SRAM), a Dynamic RAM (DRAM), or a combination thereof. The nonvolatile memory is a masked Read Only Memory (MROM), an Electrically Erasable Programmable ROM (EEPROM), a flash memory, or a hard disk drive, or any combination thereof. For example, the memory 1106 may include an external memory device accessible from the baseband processor 1103, the application processor 1104, and the SoC 1105. The memory 1106 may include an embedded memory device integrated within the baseband processor 1103, within the application processor 1104, or within the SoC 1105. Further, the memory 1106 may include a memory in a universal integrated circuit card (UICC).

The memory 1106 may store a software module (computer program) including a group of instructions and data for performing processing by the wireless terminal 20 or the like described in example embodiments as described above. In some implementations, the baseband processor 1103 or the application processor 1104 may be configured to perform processing of the wireless terminal 20 or the like described in the example embodiments as described above by reading the software module from the memory 1106 and executing it.

In the above-described example, the program includes a group of instructions (or software codes) for causing a computer to execute one or more functions described in the example embodiments in a case where the program is read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. By way of example, and not limitation, transitory computer-readable or communication media include electrical, optical, acoustic, or other forms of propagated signals.

Note that the technical ideas of the present disclosure are not limited to the above-described example embodiments, and can be appropriately modified without departing from the scope.

Some or all of the above-described example embodiments may be described as in the following Supplementary Notes, but are not limited to the following Supplementary Notes.

### Supplementary Note 1

A base station including:
a transmission unit configured to transmit, to at least one wireless terminal, instruction information instructing to transmit flight-related information regarding the wireless terminal in an RRC INACTIVE state: and
a reception unit configured to receive, from the wireless terminal that has received the instruction information, the flight-related information in the RRC INACTIVE state.

### Supplementary Note 2

The base station according to supplementary note 1, wherein the reception unit receives the flight-related information transmitted by using small data transmission (SDT).

### Supplementary Note 3

The base station according to supplementary note 1 or 2, wherein the transmission unit broadcasts the instruction information to all the wireless terminals existing in a cell managed by the base station.

### Supplementary Note 4

The base station according to supplementary note 1 or 2, wherein the transmission unit designates a specific wireless terminal to transmit the instruction information.

### Supplementary Note 5

The base station according to supplementary note 4, wherein the transmission unit transmits, to the wireless terminal in an RRC ACTIVE state, state instruction information instructing to transition to the RRC INACTIVE state, and the state instruction information includes the instruction information.

### Supplementary Note 6

The base station according to any one of supplementary notes 1 to 5, wherein the instruction information includes information instructing a timing at which the wireless terminal transmits the flight-related information.

### Supplementary Note 7

The base station according to any one of supplementary notes 1 to 6, wherein the instruction information includes information regarding a threshold value regarding a data amount of the flight-related information held by the wireless terminal, and the wireless terminal transmits the flight-related information to the base station in a case where the data amount of the held flight-related information reaches the threshold value.

### Supplementary Note 8

A wireless terminal including:
a reception unit configured to receive, from a base station, instruction information instructing to transmit flight-related information in an RRC INACTIVE state: and
a transmission unit configured to transmit the flight-related information to the base station in the RRC INACTIVE state on the basis of the instruction information.

### Supplementary Note 9

The wireless terminal according to supplementary note 8, wherein the transmission unit transmits the flight-related information to the base station by using small data transmission (SDT).

### Supplementary Note 10

The wireless terminal according to supplementary note 8 or 9, wherein the instruction information includes information instructing a timing at which the wireless terminal transmits the flight-related information.

### Supplementary Note 11

The wireless terminal according to any one of supplementary notes 8 to 10, wherein
the instruction information includes information regarding a threshold value regarding a data amount of the flight-related information held by the wireless terminal, and
the transmission unit transmits the flight-related information to the base station in a case where the data amount of the held flight-related information reaches the threshold value.

### Supplementary Note 12

A communication method executed in a base station, including:
transmitting, to at least one wireless terminal, instruction information instructing to transmit flight-related information regarding the wireless terminal in an RRC INACTIVE state: and
receiving, from the wireless terminal that has received the instruction information, the flight-related information in the RRC INACTIVE state.

### Supplementary Note 13

The communication method according to supplementary note 12, wherein in a case where the flight-related information is received, the flight-related information transmitted by using small data transmission (SDT) is received.

### Supplementary Note 14

The communication method according to supplementary note 12 or 13, wherein in a case where the instruction information is transmitted, the instruction information is broadcasted to all the wireless terminals existing in a cell managed by the base station.

### Supplementary Note 15

The communication method according to supplementary note 12 or 13, wherein in a case where the instruction information is transmitted, a specific wireless terminal is designated to transmit the instruction information.

### Supplementary Note 16

The communication method according to supplementary note 15, wherein in a case where the instruction information is transmitted, state instruction information instructing to transition to the RRC INACTIVE state is transmitted to the wireless terminal in an RRC ACTIVE state, and the state instruction information includes the instruction information.

### Supplementary Note 17

The communication method according to any one of supplementary notes 12 to 16, wherein the instruction information includes information instructing a timing at which the wireless terminal transmits the flight-related information.

### Supplementary Note 18

The communication method according to any one of supplementary notes 12 to 17, wherein the instruction information includes information regarding a threshold value regarding a data amount of the flight-related information held by the wireless terminal, and the wireless terminal transmits the flight-related information to the base station in a case where the data amount of the held flight-related information reaches the threshold value.

### Supplementary Note 19

A communication method executed in a wireless terminal, including:
receiving, from a base station, instruction information instructing to transmit flight-related information in an RRC INACTIVE state: and
transmitting the flight-related information to the base station in the RRC INACTIVE state on the basis of the instruction information.

### Supplementary Note 20

The communication method according to supplementary note 19, wherein in a case where the flight-related information is transmitted, the flight-related information is transmitted to the base station by using small data transmission (SDT).

### Supplementary Note 21

The communication method according to supplementary note 19 or 20, wherein the instruction information includes information instructing a timing at which the wireless terminal transmits the flight-related information.

### Supplementary Note 22

The communication method according to any one of supplementary notes 19 to 21, wherein
the instruction information includes information regarding a threshold value regarding a data amount of the flight-related information held by the wireless terminal, and
in a case where the flight-related information is transmitted, the flight-related information is transmitted to the base station in a case where the data amount of the held flight-related information reaches the threshold value.

### Supplementary Note 23

A program for causing a computer to execute:
transmitting, to at least one wireless terminal, instruction information instructing to transmit flight-related information regarding the wireless terminal in an RRC INACTIVE state: and
receiving, from the wireless terminal that has received the instruction information, the flight-related information in the RRC INACTIVE state.

### Supplementary Note 24

The program according to supplementary note 23, the program for causing the computer to execute: receiving, in a case where the flight-related information is received, the flight-related information transmitted by using small data transmission (SDT).

### Supplementary Note 25

The program according to supplementary note 23 or 24, the program for causing the computer to execute: broadcasting, in a case where the instruction information is transmitted, the instruction information to all the wireless terminals existing in a cell managed by the base station.

### Supplementary Note 26

The program according to supplementary note 23 or 24, the program for causing the computer to execute: designating, in a case where the instruction information is transmitted, a specific wireless terminal to transmit the instruction information.

### Supplementary Note 27

The program according to supplementary note 26, the program for causing the computer to execute: transmitting, in a case where the instruction information is transmitted, state instruction information instructing to transition to the RRC INACTIVE state to the wireless terminal in an RRC ACTIVE state, wherein the state instruction information includes the instruction information.

### Supplementary Note 28

The program according to any one of supplementary notes 23 to 27, wherein the instruction information includes information instructing a timing at which the wireless terminal transmits the flight-related information.

### Supplementary Note 29

The program according to any one of supplementary notes 23 to 28, wherein the instruction information includes information regarding a threshold value regarding a data amount of the flight-related information held by the wireless terminal, and the wireless terminal transmits the flight-related information to the base station in a case where the data amount of the held flight-related information reaches the threshold value.

### Supplementary Note 30

A program for causing a computer to execute:
receiving, from a base station, instruction information instructing to transmit flight-related information in an RRC INACTIVE state: and
transmitting the flight-related information to the base station in the RRC INACTIVE state on the basis of the instruction information.

### Supplementary Note 31

The program according to supplementary note 30, the program for causing the computer to execute: transmitting, in a case where the flight-related information is received, the flight-related information to the base station by using small data transmission (SDT).

### Supplementary Note 32

The program according to supplementary note 30 or 31, wherein the instruction information includes information instructing a timing at which the wireless terminal transmits the flight-related information.

### Supplementary Note 33

The program according to any one of supplementary notes 30 to 32, wherein the instruction information includes information regarding a threshold value regarding a data amount of the flight-related information held by the wireless terminal, the program for causing the computer to execute:
transmitting, in a case where the flight-related information is transmitted, the flight-related information to the base station in a case where the data amount of the held flight-related information reaches the threshold value.

Although the present disclosure has been described with reference to the example embodiments, the present disclosure is not limited to the example embodiments described above. Various modifications that can be understood by those skilled in the art can be made to the configurations and details of the present disclosure within the scope of the present disclosure. Then, each example embodiment can be appropriately combined with another example embodiment.

Each drawing is merely illustrative for describing one or more example embodiments. Each drawing is not associated with only one specific example embodiment, but may be associated with one or more other example embodiments. As one of ordinary skill in the art will appreciate, various features or steps described with reference to any one of the drawings may be combined with features or steps shown in one or more other drawings, for example, to create an example embodiment not explicitly illustrated or described. All of the features or steps shown in any one of the drawings for describing example embodiments are not necessarily mandatory, and some features or steps may be omitted. The order of the steps described in any drawing may be changed as appropriate.

This application claims priority based on Japanese Patent Application No. 2022-122191 filed on Jul. 29, 2022, the entire disclosure of which is incorporated herein.

### REFERENCE SIGNS LIST

10 BASE STATION
11 TRANSMISSION UNIT
12 RECEPTION UNIT
20 WIRELESS TERMINAL
21 RECEPTION UNIT
22 TRANSMISSION UNIT
30 gNB
41 UE
42 UE
50 UPF
60 UTM

What is claimed is:

1. 1-7. (canceled)

8. A wireless terminal comprising:
at least one memory storing instructions; and
at least one processor configured to execute the instructions to,
receive, from a base station, instruction information instructing to transmit flight-related information in an RRC INACTIVE state; and
transmit the flight-related information to the base station in the RRC INACTIVE state on a basis of the instruction information.

9. The wireless terminal according to claim 8, wherein the at least one processor is further configured to execute the instructions to transmit the flight-related information to the base station by using small data transmission (SDT).

10. The wireless terminal according to claim 8, wherein the instruction information includes information instructing a timing at which the wireless terminal transmits the flight-related information.

11. The wireless terminal according to claim 8, wherein
the instruction information includes information regarding a threshold value regarding a data amount of the flight-related information held by the wireless terminal, and
the at least one processor is further configured to execute the instructions to transmit the flight-related information to the base station in a case where the data amount of the held flight-related information reaches the threshold value.

12. A communication method executed in a base station, comprising:
transmitting, to at least one wireless terminal, instruction information instructing to transmit flight-related information regarding the wireless terminal in an RRC INACTIVE state; and
receiving, from the wireless terminal that has received the instruction information, the flight-related information in the RRC INACTIVE state.

13. The communication method according to claim 12, wherein in a case where the flight-related information is received, the flight-related information transmitted by using small data transmission (SDT) is received.

14. The communication method according to claim 12, wherein in a case where the instruction information is transmitted, the instruction information is broadcasted to all the wireless terminals existing in a cell managed by the base station.

15. The communication method according to claim 12, wherein in a case where the instruction information is transmitted, a specific wireless terminal is designated to transmit the instruction information.

16. The communication method according to claim 15, wherein in a case where the instruction information is transmitted, state instruction information instructing to transition to the RRC INACTIVE state is transmitted to the wireless terminal in an RRC ACTIVE state, and the state instruction information includes the instruction information.

17. The communication method according to claim 12, wherein the instruction information includes information instructing a timing at which the wireless terminal transmits the flight-related information.

18. A communication method executed in a wireless terminal, comprising:
receiving, from a base station, instruction information instructing to transmit flight-related information in an RRC INACTIVE state; and
transmitting the flight-related information to the base station in the RRC INACTIVE state on a basis of the instruction information.

19-20. (canceled)

21. The communication method according to claim 12, wherein the instruction information includes information regarding a threshold value regarding a data amount of the flight-related information held by the wireless terminal, and the wireless terminal transmits the flight-related information to the base station in a case where the data amount of the held flight-related information reaches the threshold value.

22. The communication method according to claim 18, wherein in a case where the flight-related information is transmitted, the flight-related information is transmitted to the base station by using small data transmission (SDT).

23. The communication method according to claim 18, wherein the instruction information includes information instructing a timing at which the wireless terminal transmits the flight-related information.

24. The communication method according to claim 18, wherein
the instruction information includes information regarding a threshold value regarding a data amount of the flight-related information held by the wireless terminal, and
in a case where the flight-related information is transmitted, the flight-related information is transmitted to the base station in a case where the data amount of the held flight-related [symbol]
